(19) United States
(12) Patent Application Publication
(10) Pub. No.: US 2008/0219391 A1
(43) Pub. Date: Sep. 11, 2008

(54) Systems and Methods for Distributing a Clock Signal

(75) Inventor: Roland Joseph Moubarak, Sachse, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/683,200

(22) Filed: Mar. 7, 2007

(51) Int. Cl. H04L 7/00

(52) U.S. Cl. 375/356

(57) ABSTRACT

One embodiment of the present invention includes a distributed clock system. The distributed clock system includes a clock transmitter configured to programmably amplify and transmit a sine-wave signal corresponding to a clock signal, and a clock receiver configured to receive the sine-wave signal and to convert the sine-wave signal into a square-wave clock signal.

### TECHNICAL FIELD

This invention relates to electronic circuits, and more specifically to systems and methods of distributing a clock signal.

### BACKGROUND

As the demand for electronic devices increases, technology has improved to provide designs for electronic devices that operate more quickly and efficiently. In a given electronic device, many interconnected components are designed to operate based on very specific timing relative to each other. As such, typical electronic devices operate using a clock signal. As a result, the operation of different components in an electronic device can be synchronized for fast and efficient operation. Because digital components in an electronic device are designed to operate very quickly and be synchronized relative to each other, a typical clock signal is implemented as a square-wave, such that a logic change from logic-low to logic-high, or vice-verse, occurs almost instantaneously. Therefore, the digital components can trigger state changes very quickly and can substantially minimize timing mismatches relative to each other.

Because separate digital components are often required to operate synchronously, a common clock signal is typically implemented. As digital components are often physically separated in a given electronic device, a common clock signal is typically generated at one source and transmitted to the other digital components in the electronic device. However, as the square-wave clock signal propagates on the transmission medium, the square-wave clock signal becomes subject to attenuation, such that it loses signal amplitude and becomes distorted. The distortion and amplitude loss can affect the operational speed and efficiency of the target device for which the clock signal is intended. In addition, a typical high-frequency square-wave can generate a substantial amount of electromagnetic interference (EMI), which can affect the performance of other digital components of the electronic device.

### SUMMARY

One embodiment of the present invention includes a distributed clock system. The distributed clock system includes a clock transmitter configured to programmably amplify and transmit a sine-wave signal corresponding to a clock signal, and a clock receiver configured to receive the sine-wave signal and to convert the sine-wave signal into a square-wave clock signal.

Another embodiment of the present invention includes a method for distributing a clock signal. The method comprises amplifying a sine-wave signal by a gain amount and transmitting the sine-wave signal on a transmission medium. The sine-wave signal can correspond to a clock signal. The gain amount can be proportional to a length of the transmission medium on which the sine-wave signal propagates. The method also comprises converting the transmitted sine-wave signal to a square-wave clock signal at a clock receiver.

Another embodiment of the present invention includes a distributed clock system. The system comprises a clock transmitter configured to programmably amplify and transmit a plurality of sine-wave signals. Each of the plurality of sine-wave signals can correspond to a clock signal. The system also comprises a plurality of clock receivers each configured to receive one of the plurality of sine-wave signals and to convert the respective one of the plurality of sine-wave signals into a square-wave clock signal.

### BRIEF DESCRIPTION OF THE DRAWINGS

FIG. 1 illustrates an example of a distributed clock system in accordance with an aspect of the invention.

FIG. 2 illustrates an example of a programmable clock amplifier in accordance with an aspect of the invention.

FIG. 3 illustrates an example of a clock terminator in accordance with an aspect of the invention.

FIG. 4 illustrates another example of a programmable clock amplifier in accordance with an aspect of the invention.

FIG. 5 illustrates another example of a distributed clock system in accordance with an aspect of the invention.

FIG. 6 illustrates an example of a method for distributing a clock signal in accordance with an aspect of the invention.

### DETAILED DESCRIPTION

The present invention relates to electronic circuits, and more specifically to systems and methods of distributing a clock signal. A distributed clock system can be included in any of a variety of systems, such as, for example, a personal computer, mobile communications device, a network server, or any of a variety of electronic devices that includes one or more digital components that implement a clock signal and are separated via a backplane or data bus. A distributed clock system includes a clock transmitter and one or more clock receivers. The clock transmitter includes a programmable clock amplifier configured to convert a square-wave clock signal into a sine-wave signal corresponding to the square-wave clock signal. The sine-wave signal is amplified by one or more linear amplifiers that are programmed with a predetermined gain amount, such as can be stored on a memory. The predetermined gain amount can be proportional to a length of a transmission medium on which the sine-wave signal propagates between the clock transmitter and a clock receiver. A clock receiver includes a clock terminator that converts the sine-wave signal into a square-wave clock signal having a signaling protocol for which a target device is configured. As such, a clock signal can be transmitted across a transmission medium with substantial mitigation of electromagnetic interference (EMI) and attenuation, such that the target device can implement the clock signal with improved operational speed and efficiency.

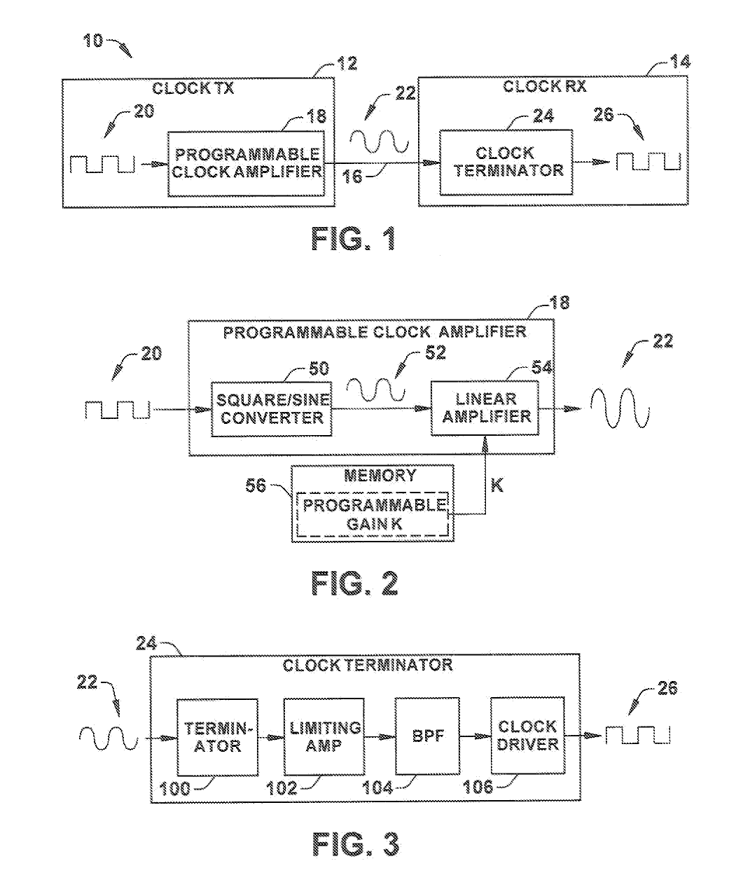

FIG. 1 illustrates an example of a distributed clock system 10 in accordance with an aspect of the invention. The distributed clock system 10 can be implemented in a variety of different systems, such as a computer system, a network system, and/or a communication system. The distributed clock system 10 includes a clock transmitter 12 and a clock receiver 14 separated by a transmission medium 16. The transmission medium 16 can be, for example, a conductor that is part of a bus or attached to a printed circuit board (PCB) or backplane. Therefore, the clock transmitter 12 and the clock receiver 14 can be included on separate integrated circuits (ICs) that are mounted on the same electronic component, such as the same PCB, or can each be included on separate PCBs in the same or in separate electronic device.

The clock transmitter 12 includes a programmable clock amplifier 18 that can be configured to receive a clock signal 20. Although the example of FIG. 1 demonstrates that the clock signal 20 is a square-wave clock signal, it is to be understood that the clock transmitter could instead receive a sine-wave clock signal. The clock signal 20 can be generated, for example, from a crystal oscillator (not shown) that can be included in the clock transmitter 12 or can be included in an external component from which the clock signal 20 is provided to the clock transmitter 12. The programmable clock amplifier 18 can be further configured to generate an amplified sine-wave signal 22 that corresponds to the clock signal 20. The sine-wave signal 22 is thus transmitted from the clock transmitter 12 to the clock receiver 14.

FIG. 2 illustrates an example of the programmable clock amplifier 18 in accordance with an aspect of the invention. The programmable clock amplifier 18 in the example of FIG. 2 can be substantially the same as the programmable clock amplifier 18 in the example of FIG. 1 included in the clock transmitter 12, and thus is given a like reference number. Therefore, in the discussion of the example of FIG. 2, reference will be made and like reference numbers will be used as in the example of FIG. 1.

Similar to as described above in the example of FIG. 1, the clock signal 20, such as could be generated from a crystal oscillator, is input to the programmable clock amplifier 18. The clock signal 20 is provided to a square/sine converter 50 that is configured to convert the clock signal 20 into a sine-wave signal 52 that corresponds to the clock signal 20. For example, the sine-wave signal 52 can have a frequency that is equal to or is a multiple (e.g., one-half) of the clock signal 20. The square/sine converter 50 can be any of a variety of devices configured to generate a sine-wave from a square-wave, such as a frequency generator. In addition, as described above in the example of FIG. 1, the programmable clock amplifier 18 could receive the clock signal 20 as a sine-wave clock signal instead of implementing the square/sine converter 50, such that the clock signal 20 could be provided directly as the sine-wave signal 52.

The sine-wave signal 52 is input to a linear amplifier 54 that is configured to amplify the sine-wave signal 52 by a programmable gain K to generate the amplified sine-wave signal 22, where K is a positive number. The programmable gain K can be proportional to a length of the transmission medium 16 on which the amplified sine-wave signal 22 propagates between the clock transmitter 12 and the clock receiver 14. For example, the programmable gain K can be relatively higher for a longer length of the transmission medium 16, such as upon the clock transmitter 12 and the clock receiver 14 being located on separate PCBs. As another example, the programmable gain K can be relatively lower for a shorter length of the transmission medium 16, such as upon the clock transmitter 12 and the clock receiver 14 being located in close proximity to each other on the same PCB. As a result, the amplitude of the amplified sine-wave signal 22 can be optimized for the distance it travels from the clock transmitter 12 to the clock receiver 14 to balance power consumption and to maintain signal integrity.

In the example of FIG. 2, the programmable gain K can be stored in a memory 56. For example, the memory 56 can be any of a variety of non-volatile memory types, such as an EEPROM, that includes the programmable gain K in a predetermined memory location. As demonstrated in the example of FIG. 2, the memory 56 can be configured external to the programmable gain amplifier 18. For example, the memory 56 can be included in the clock transmitter 12, or can be configured separately from the clock transmitter 12. In addition, the memory 56 can include operational RAM for other electronic components in the system in which the distributed clock system 10 is included.

It is to be understood that the programmable clock amplifier 18 is not intended to be limited to the example of FIG. 2. As an example, the programmable clock amplifier 18 could include one or more additional components, such as a frequency divider configured to reduce the frequency of the amplified sine-wave signal 22. As another example, the programmable clock amplifier 18 could also be configured to provide the amplified sine-wave signal 22 as a differential signal, as opposed to the single-ended signal demonstrated in the example of FIGS. 1 and 2. Furthermore, as yet another example, the programmable clock amplifier 18 could include an oscillator configured to generate a sine-wave directly at a specific frequency, such that the square/sine converter 50 can be omitted. Therefore, the programmable clock amplifier 18 can be configured in any of a variety of different ways.

Referring back to the example of FIG. 1, the amplified sine-wave signal 22 propagates on the transmission medium 16 from the clock transmitter 12 to the clock receiver 14. The clock receiver 14 inputs the amplified sine-wave signal 22 to a clock terminator 24. The clock terminator 24 is configured to convert the amplified sine-wave signal 22 back to a square-wave clock signal 26. The square-wave clock signal 26 can have substantially the same frequency and phase as the clock signal 20 of the clock transmitter 12. Therefore, the clock signal 20 can be distributed across the transmission medium 16 as the amplified sine-wave signal 22. The square-wave clock signal 26 can thus be implemented by one or more target devices (not shown).

FIG. 3 illustrates an example of the clock terminator 24 in accordance with an aspect of the invention. The clock terminator 24 in the example of FIG. 3 can be substantially the same as the clock terminator 24 in the example of FIG. 1 included in the clock receiver 14, and thus is given a like reference number. Therefore, in the discussion of the example of FIG. 3, reference will be made and like reference numbers will be used as in the example of FIG. 1.

As described above, the clock terminator 24 receives the amplified sine-wave signal 22 via the transmission medium 16. The amplified sine-wave signal 22 is input to a termination element 100. The termination element 100 is configured to provide impedance matching for a transmission line driving the clock terminator 24. As such, reflection induced by a mismatch between the input impedance and the transmission line driving the clock terminator 24 can be minimized.

The amplified sine-wave 22 is then provided to a limiting amplifier 102. The limiting amplifier 102 is configured to amplify and convert the amplified sine-wave signal 22 to a corresponding square-wave signal. For example, the limiting amplifier 102 can amplify the amplified sine-wave signal 22 to saturation, such that the resultant signal is a square-wave having a substantially equal frequency and phase as the amplified sine-wave signal 22. The resultant corresponding square-wave signal is then input to a band-pass filter (BPF) 104 configured to remove unwanted frequency components from the resultant corresponding square-wave signal, such as resulting from noise. It is to be understood that the BPF 104 may not be necessary in environments that are less susceptible to noise, and can thus be optional.

Upon being band-pass filtered, the filtered square-wave signal is provided to a clock driver 106. The clock driver 106 is configured to provide the filtered square-wave signal as one of a variety of different industry standard clock signaling protocols, either single-ended or differential. For example, the clock driver 106 could provide the clock signal as a low-voltage differential signal (LVDS), positive emitter coupled logic signal (PECL), low-voltage positive emitter coupled logic signal (LVPECL), or any of a variety of other signaling protocols as dictated by an intended target device for which the clock signal is intended. As described above, the termination element 100 provides impedance matching for a transmission line driving the clock terminator 24. Therefore, the filtered signal output from the clock terminator 24 can be provided as a standard clock signal 26 to a target device.

It is to be understood that the clock terminator 24 is not intended to be limited to the example of FIG. 3. As an example, the clock terminator 24 could include more or less components than depicted in the example of FIG. 3. As another example, the clock terminator 24 could be configured directly in the target device, such that the termination element 100 could be omitted. Furthermore, the clock terminator 24 is not limited to receiving a sine-wave signal, but also be configured to receive a square-wave clock signal directly. As such, the clock terminator 24 could substantially mitigate attenuation and/or distortion of a received square-wave clock signal resulting from propagation on the transmission medium from which the square-wave clock signal is provided. Therefore, the programmable clock amplifier 18 can be configured in any of a variety of different ways.

As described above, a given sine-wave signal can generate substantially less EMI than a given square-wave signal. Therefore, as a result of the conversion of the clock signal 20 to the amplified sine-wave signal 22, the transmission of the amplified sine-wave signal 22 to the clock receiver 14 can generate less EMI than if the clock signal 20 was transmitted to the clock receiver 14 directly. In addition, a given sine-wave signal can be subject to less attenuation resulting from the transmission medium than a given square-wave. As a result, because the clock signal 20 is transmitted to the clock receiver 14 as a sine-wave that is amplified, the clock receiver 14 can receive the clock signal accurately and reliably, such that the square-wave clock signal 26 has substantially the same frequency and phase as the clock signal 20.

It is to be understood that the distributed clock system 10 is not intended to be limited to the example of FIG. 1. As an example, the clock transmitter 12 and the programmable clock amplifier 18 could be implemented as the same component, as could the clock receiver 14 and the clock terminator 24. As another example, the transmission medium 16 may not be a physical medium, such that the clock transmitter 12 and the clock receiver 14 could include wireless transmission and reception components, respectively. Therefore, the distributed clock system 10 in the example of FIG. 1 can be configured in any of a variety of different ways.

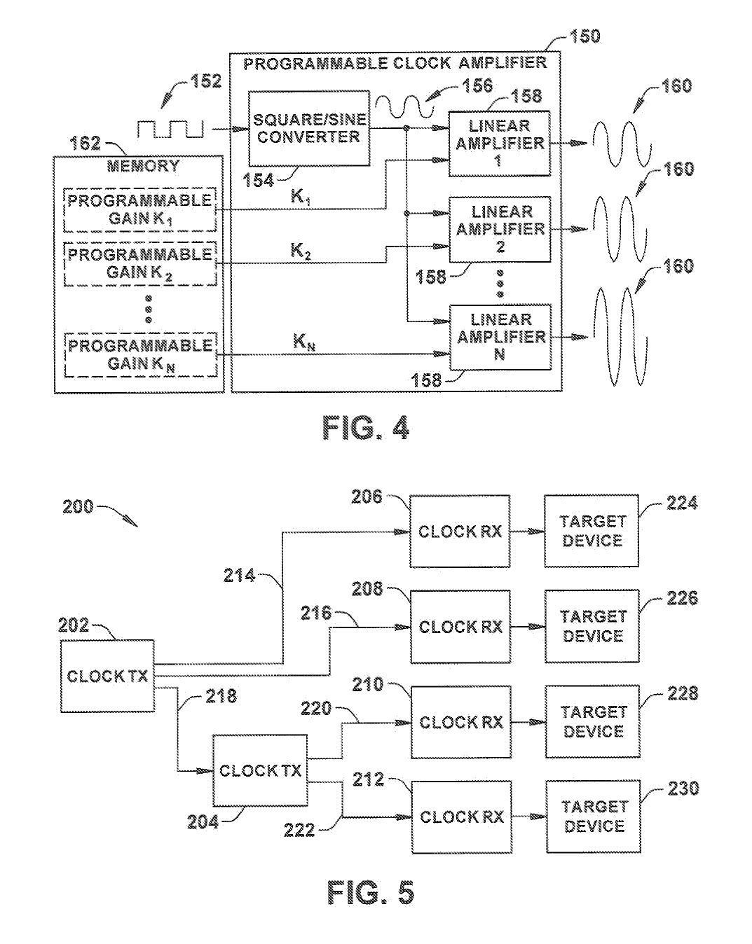

FIG. 4 illustrates another example of a programmable clock amplifier 150 in accordance with an aspect of the invention. Similar to as described above regarding the example of FIGS. 1 and 2, a square-wave clock signal 152, such as could be generated from a crystal oscillator, is input to the programmable clock amplifier 150. The square-wave clock signal 152 is provided to a square/sine converter 154 that is configured to convert the square-wave clock signal 152 into a sine-wave signal 156 that corresponds to the square-wave clock signal 152. For example, the sine-wave signal 156 can have a frequency that is equal to or is a multiple (e.g., one-half) of the square-wave clock signal 152. The square/sine converter 154 can be any of a variety of devices configured to generate a sine-wave from a square-wave, such as a frequency generator.

In the example of FIG. 4, the sine-wave signal 156 is input to a plurality of linear amplifiers 158, labeled Linear Amplifier 1 through Linear Amplifier N, where N is a positive integer greater than one. Each of the plurality of linear amplifiers 158 is configured to amplify the sine-wave signal 156 by a respective programmable gain K₁ through K_{N} to generate a respective plurality of amplified sine-wave signals 160, where each of the programmable gains K₁ through K_{N} are positive numbers. Each of the plurality of amplified sine-wave signals 160 can be transmitted to each of a plurality of separate clock receivers (not shown). Each of the programmable gains K₁ through K_{N} can be proportional to a length of the transmission medium on which each of the plurality of amplified sine-wave signals 160 propagates between the clock transmitter in which the programmable clock amplifier 150 is included and each of the respective clock receivers.

As an example, each of the programmable gains K₁ through K_{N} can have relatively higher values for longer lengths of transmission media, and can have relatively lower values for shorter lengths of transmission media. In the example of FIG. 4, the relative amplitudes of the amplified sine-wave signals 160 demonstrate that the programmable gain K₁ has a lower gain value than the programmable gain K₂, which has a lower gain value than the programmable gain K_{N}. Therefore, ad depicted in the example of FIG. 4, the Linear Amplifier N is configured to provide the amplified sine-wave signal 160 on a longer transmission medium than the Linear Amplifier 2, which is configured to provide the amplified sine-wave signal 160 on a longer transmission medium than the Linear Amplifier 1. Accordingly, the amplitude of each of the amplified sine-wave signals 160 can be optimized for the distance they travel from the clock transmitter in which the programmable clock amplifier 150 is included to each of the respective clock receivers to balance power consumption and to maintain signal integrity.

In the example of FIG. 4, the programmable gains K₁ through K_{N} can be stored in a memory 162. For example, the memory 162 can be any of a variety of non-volatile memory types, such as an EEPROM, that includes each of the programmable gains K₁ through K_{N} in respective predetermined memory locations. As demonstrated in the example of FIG. 4, the memory 162 can be configured external to the programmable gain amplifier 150. For example, the memory 162 can be included in the clock transmitter in which the programmable clock amplifier 150 is included, or can be configured on a separate electronic component or PCB. In addition, the memory 162 can include operational RAM for other electronic components in the system in which the distributed clock system having the programmable clock amplifier 150 is included.

It is to be understood that the programmable clock amplifier 150 is not intended to be limited to the example of FIG. 4. As an example, the programmable clock amplifier 150 could include one or more additional components, such as a frequency divider configured to reduce the frequency of the amplified sine-wave signal 156. As another example, the programmable clock amplifier 152 could also be configured to provide any of the amplified sine-wave signals 160 as differential signals, as opposed to the single-ended signals demonstrated in the example of FIG. 4. Furthermore, as yet another example, the programmable clock amplifier 150 could include an oscillator configured to generate a sine-wave directly at a specific frequency, such that the square/sine converter 154 could be omitted. Therefore, the programmable clock amplifier 150 can be configured in any of a variety of different ways.

FIG. 5 illustrates another example of a distributed clock system 200 in accordance with an aspect of the invention. The distributed clock system 200 can be implemented in a variety of different systems, such as a computer system, a network system, and/or a communication system. The distributed clock system 200 includes a first clock transmitter 202, a second clock transmitter 204, and a plurality of clock receivers, demonstrated in the example of FIG. 5 as a first clock receiver 206, a second clock receiver 208, a third clock receiver 210, and a fourth clock receiver 212. The first clock transmitter 202 is separated from the first clock receiver 206 by a transmission medium 214, from the second clock receiver 208 by a transmission medium 216, and from the second clock transmitter 204 by a transmission medium 218. The second clock transmitter 204 is separated from the third clock receiver 210 by a transmission medium 220 and from the fourth clock receiver 212 by a transmission medium 222. The transmission mediums 214, 216, 218, 220, and 222 can be, for example, conductors that are part of one or more buses and/or attached to one or more PCBs. Therefore, the clock transmitters 202 and 204 and the clock receivers 206, 208, 210, and 212 can be included on separate ICs mounted on one or more separate electronic components in the system in which the distributed clock system 200 is included.

The first clock transmitter 202 can be configured substantially similarly to the clock transmitter 150 in the example of FIG. 4. As such, the first clock transmitter 202 can be configured to receive a square-wave clock signal, such as generated from a crystal oscillator, and to convert the square-wave clock signal to a sine-wave signal that corresponds to the square-wave clock signal. In addition, the first clock transmitter 202 can include a plurality of linear amplifiers, each configured to apply a programmable gain amount to the sine-wave signal to generate a plurality of amplified sine-wave signals. In the example of FIG. 5, the first clock transmitter 202 transmits an amplified sine-wave signal to the first clock receiver 206 on the transmission medium 214, to the second clock receiver 208 on the transmission medium 216, and to the second clock transmitter 204 on the transmission medium 218. The amount of the programmable gain for each of the amplified sine-wave signals can be proportional to the respective lengths of the transmission mediums 214, 216, and 218. Accordingly, the amplitude of each of the respective amplified sine-wave signals can be optimized for the distance they travel on the transmission mediums 214, 216, and 218 to balance power consumption and to maintain signal integrity.

The second clock transmitter 204 can likewise be configured similarly to the clock transmitter 150 in the example of FIG. 4. However, as the second clock transmitter 204 receives an amplified sine-wave signal output from the first clock transmitter 202, the second clock transmitter 204 may not include a square/sine converter. The second clock transmitter 204 can likewise include a plurality of linear amplifiers. As such, the second clock transmitter 204 can amplify the received amplified sine-wave signal output from the first clock transmitter 202 by a plurality of gain amounts. In the example of FIG. 5, the second clock transmitter 204 transmits an amplified sine-wave signal to the third clock receiver 210 on the transmission medium 220 and to the fourth clock receiver 222 on the transmission medium 212. The amount of the programmable gain for each of the amplified sine-wave signals can be proportional to the respective lengths of the transmission mediums 220 and 222. Therefore, the second clock transmitter 204 is configured to amplify and distribute the clock signal to a plurality of additional clock receivers, such as to mitigate hardware and/or spatial constraints.

Each of the clock receivers 206, 208, 210, and 212 are coupled to a target device, such that the clock receiver 206 is coupled to he target device 224, the clock receiver 208 is coupled to the target device 226, the clock receiver 210 is coupled to the target device 228, and the clock receiver 212 is coupled to the target device 230. The clock receivers 206, 208, 210, and 212 can each be configured to convert the input amplified sine-wave signal into a square-wave clock signal. In addition, the clock receivers 206, 208, 210, and 212 can also be configured to provide the square-wave clock signal as any of a variety of different industry standard clock signaling protocols, either single-ended or differential. For example, the clock receivers 206, 208, 210, and 212 could provide the clock signal having an LVDS signaling protocol, a PECL signaling protocol, an LVPECL signaling protocol, or any of a variety of other signaling protocols as dictated by the respective one of the target devices 224, 226, 228, and 230 for which the clock signal is intended.

It is to be understood that the distributed clock system 200 is not intended to be limited to the example of FIG. 5. Specifically, the example of FIG. 5 provides a simplified example of a distributed clock system, but it is to be understood that the distributed clock system 200 could include many more target devices, each with a respective clock receiver. Therefore, the distributed clock system 200 could include many additional clock transmitters coupled to the outputs of he clock transmitter 202 and/or the clock transmitter 204, such that amplified sine-wave signals can be branched-out and provided to all of the clock receivers that are configured to provide the square-wave clock signal to the target devices. Furthermore, it is to be understood that a given clock receiver is not limited to a single target device, but could provide the square-wave clock signal having a given signal protocol to more than one target device. Accordingly, the distributed clock system 200 can be implemented in any of a variety of different ways.

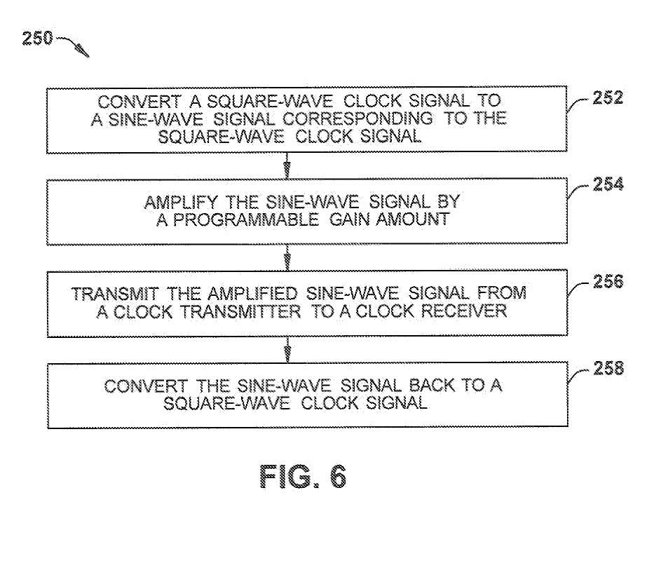

In view of the foregoing structural and functional features described above, certain methods will be better appreciated with reference to FIG. 6. It is to be understood and appreciated that the illustrated actions, in other embodiments, may occur in different orders and/or concurrently with other actions. Moreover, not all illustrated features may be required to implement a method.

FIG. 6 illustrates a method 250 for distributing a clock signal in accordance with an aspect of the invention. At 252, a square-wave clock signal is converted to a sine-wave signal corresponding to the square-wave clock signal. The square-wave clock signal can be generated from a crystal oscillator or other type of clock generator. The sine-wave signal can have the same frequency as the square-wave clock signal, or can have a frequency that is a multiple of the square-wave clock signal. At 254, the sine-wave signal is amplified by a programmable gain amount. The programmable gain amount can be proportional to a length of a physical transmission medium on which the amplified sine-wave signal is to propagate. The programmable gain amount can be stored in a memory, such as an EEPROM.

At 256, the amplified sine-wave signal is transmitted from a clock transmitter to a clock receiver. The clock transmitter and the clock receiver can be included in an IC mounted on the same electronic component, such as the same PCB, or can each be included on separate PCBs in the same or in separate electronic devices. At 258, the sine-wave signal is converted back to a square-wave clock signal. The resultant square-wave clock signal can have substantially the same frequency and phase as the original square-wave clock signal, and can be provided as any of a number of industry standard signaling protocols to one or more target devices.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A system comprising:
a clock transmitter configured to programmably amplify and transmit a sine-wave signal corresponding to a clock signal; and
a clock receiver configured to receive the sine-wave signal and to convert the sine-wave signal into a square-wave clock signal.

2. The system of claim 1, wherein the clock transmitter comprises a linear amplifier configured to programmably amplify the sine-wave signal by a programmable gain amount that is proportional to a length of a transmission medium separating the clock receiver and the clock transmitter on which the sine-wave signal propagates.

3. The system of claim 2, further comprising a memory configured to store the programmable gain amount.

4. The system of claim 1, wherein the clock signal is a first square-wave clock signal and the square-wave clock signal is a second square-wave clock signal, and wherein the clock transmitter comprises a conversion component configured to convert the first square-wave clock signal into the sine-wave signal.

5. The system of claim 1, wherein the clock receiver comprises a limiting amplifier configured to amplify and convert the sine-wave signal to the square-wave clock signal.

6. The system of claim 1, wherein the clock receiver comprises a clock driver configured to provide the square-wave clock signal as one of a plurality of clock signaling protocols.

7. The system of claim 1, wherein the clock transmitter comprises a plurality of linear amplifiers, the plurality of linear amplifiers being configured to amplify the sine-wave signal by a respective plurality of gain amounts to generate a respective plurality of amplified sine-wave signals.

8. The system of claim 7, wherein the clock receiver is one of a plurality of clock receivers, each of the plurality of clock receivers receiving one of the plurality of amplified sine-wave signals and to convert the respective amplified sine-wave signal into a respective square-wave clock signal.

9. The system of claim 8, wherein each of the plurality of clock receivers comprises a clock driver configured to provide the respective one of the plurality of square-wave clock signals as one of a plurality of clock signaling protocols to a respective target device.

10. The system of claim 7, further comprising at least one additional clock transmitter configured to receive one of the plurality of amplified sine-wave signals, the at least one additional clock transmitter comprising a second plurality of linear amplifiers configured to amplify the one of the plurality of amplified sine-wave signals by a second respective plurality of gain amounts to generate a second respective plurality of amplified sine-wave signals.

11. A method for distributing a clock signal, the method comprising:
amplifying a sine-wave signal by a programmable gain amount, the sine-wave signal corresponding to a clock signal;
transmitting the sine-wave signal on a transmission medium, the programmable gain amount being proportional to a length of the transmission medium on which the sine-wave signal propagates; and
converting the transmitted sine-wave signal to a square-wave clock signal at a clock receiver.

12. The method of claim 11, further comprising programming the gain amount in a memory.

13. The method of claim 11, wherein the clock signal is a first square-wave clock signal and the square-wave clock signal is a second square-wave clock signal, the method further comprising converting the first square-wave clock signal into the sine-wave signal.

14. The method of claim 11, further comprising providing the square-wave clock signal as one of a plurality of clock signaling protocols to a target device.

15. The method of claim 11, wherein amplifying the sine-wave signal comprises amplifying the sine-wave signal with a plurality of gain amounts to generate a plurality of amplified sine-wave signals, and wherein transmitting the sine-wave signal comprises transmitting the plurality of amplified sine-wave signals to a respective plurality of clock receivers.

16. A system comprising:
a clock transmitter configured to programmably amplify and transmit a plurality of sine-wave signals, each of the plurality of sine-wave signals corresponding to a clock signal; and
a plurality of clock receivers each configured to receive one of the plurality of sine-wave signals and to convert the respective one of the plurality of sine-wave signals into a square-wave clock signal.

17. The system of claim 16, wherein the clock transmitter comprises a plurality of linear amplifiers, the plurality of linear amplifiers being configured to amplify the sine-wave signal by a plurality of gain amounts associated with each of the respective plurality of sine-wave signals.

18. The system of claim 16, further comprising a memory configured to store the plurality of gain amounts.

19. The system of claim 16, wherein each of the plurality of clock receivers comprises a clock driver configured to provide the respective one of the plurality of square-wave clock signals as one of a plurality of clock signaling protocols to a respective target device.

20. The system of claim 16, further comprising at least one additional clock transmitter configured to receive one of the plurality of sine-wave signals, the at least one additional clock transmitter comprising a second plurality of linear amplifiers configured to amplify the one of the plurality of amplified sine-wave signals by a second plurality of gain amounts to generate a second respective plurality of sine-wave signals.
